(19) United States
(12) Patent Application Publication
(10) Pub. No.: US 2025/0356315 A1
(43) Pub. Date: Nov. 20, 2025

(54) Integrated Real-Time Issue Reporting and AI-Enhanced Communication Platform for Product Management

(71) Applicants: Charles Polanco, Scarsdale, NY (US); Primavera Polanco, Scarsdale, NY (US)

(72) Inventors: Charles Polanco, Scarsdale, NY (US); Primavera Polanco, Scarsdale, NY (US)

(21) Appl. No.: 18/668,178

(22) Filed: May 19, 2024

(51) Int. Cl. G06Q 10/10; G06F 40/30

(52) U.S. Cl. CPC G06Q 10/103; G06F 40/30

(57) ABSTRACT

The present disclosure relates to Wallow, a communication and collaboration platform for product management teams. It integrates real-time issue reporting, AI-enhanced analytics, and inclusive communication strategies. Team members can instantly report issues, ensuring immediate awareness and response. Wallow's AI module analyzes communication data to provide insights on issue frequency, recurring problems, and sentiment. The platform features a dedicated space for managing active issues, prioritizing unresolved problems. Additionally, Wallow supports the creation of functional teams and offers a centralized hub for all product-related information, enhancing team coordination and information sharing. This comprehensive approach improves efficiency and responsiveness, addressing the unique challenges of product development.

### BACKGROUND OF THE INVENTION

### Field of the Invention

The present invention pertains to the field of digital communication tools specifically designed to enhance collaboration and management within product development teams.

### Description of the Related Art

Traditional communication tools such as Slack and Microsoft Teams facilitate general workplace communication through features like channels, direct messaging, and file sharing. However, these tools often lack specific functionalities tailored for the unique demands of product management, such as handling real-time issue reporting, providing AI-driven insights, and integrating comprehensive project tracking within a single platform.

Product management requires a detailed and dynamic approach to handling various types of information and activities, including issue tracking, team collaboration on specific problems, and strategic planning based on real-time data. Current tools typically segregate these functions into different platforms or require extensive customization, which can lead to inefficiencies, a lack of real-time responsiveness, and increased complexity in communication.

Furthermore, existing platforms do not adequately address the need for all team members to be immediately aware of and respond to new issues as they arise without the need for pre-configured notifications settings or membership in specific discussion groups. This can delay the resolution of critical issues and hinder the overall agility and effectiveness of the team.

Moreover, while some tools incorporate AI to aid in data analysis, they often do not tailor these capabilities specifically for product management needs, such as analyzing the sentiment of communications to gauge urgency or synthesizing updates into actionable insights.

Therefore, there is a clear need for an improved communication tool specifically designed for product management, which integrates real-time issue reporting, AI-enhanced analytics, and inclusive communication mechanisms to support dynamic and efficient team collaboration.

### SUMMARY OF THE INVENTION

The present invention, Wallow, introduces a novel communication and collaboration platform designed specifically for product management teams. This platform innovatively integrates features from well-established communication tools, real-time reporting systems, and AI technologies to address the unique challenges faced in product development environments.

Wallow's primary innovation lies in its comprehensive approach to real-time issue reporting, AI-enhanced analytics, and seamless communication, which are tailored to enhance productivity, transparency, and responsiveness among product management teams. The invention is distinguished by several key functionalities:

Real-Time Issue Reporting: Inspired by the immediacy of Waze's traffic reporting, Wallow allows any team member to instantly report issues as they arise. This feature ensures that all relevant team members are immediately notified and can begin collaborating on solutions without delay, thereby enhancing the team's ability to respond quickly to project challenges.

AI-Enhanced Analytics: Utilizing capabilities similar to those found in AI platforms like OpenAI, Wallow analyzes communication patterns, issue frequency, and sentiment to provide actionable insights. This allows teams to identify recurring problems, assess team sentiment, and prioritize issues based on their urgency and impact.

Inclusive Notification System: Unlike traditional tools that require users to subscribe or be added to specific channels or groups, Wallow's notification system ensures that all team members in a workspace are alerted to new issues, updates, and resolutions. This system fosters an environment where information silos are minimized, and collaborative responses are maximized.

Focused Issue Management: Wallow provides a dedicated space for tracking and managing active issues, keeping unresolved problems at the forefront of team activities. This feature helps maintain focus on priority tasks and ensures that no critical issue is overlooked.

Integrated Team Functionality: Wallow supports the creation of functional teams within the workspace, allowing for structured yet flexible team dynamics. This facilitates clear role definitions and responsibilities, enhancing the overall coordination within cross-functional teams.

Centralized Product Management Space: The platform features a centralized hub for all product-related information, including product vision, objectives, key results (OKRs), customer personas, and other essential documents and communications. This hub serves as a single source of truth, streamlining information sharing and alignment across the team.

The combination of these features makes Wallow a uniquely effective tool for managing the complexities of product development. By addressing the specific needs of product management teams through an integrated platform, Wallow significantly improves communication efficiency, issue resolution speed, and overall project management effectiveness,

### BRIEF DESCRIPTION OF THE DRAWINGS

The accompanying drawings are included to provide a further understanding of the invention and are incorporated in and constitute a part of this specification. The drawings illustrate embodiments of the invention and together with the description serve to explain the principles of the invention. In the drawings:

FIG. 1: System Architecture Diagram

Description: This diagram illustrates the overall architecture of the Wallow platform, showing the integration of real-time issue reporting, AI-driven analytics, and communication modules. It details the connections between the user interface, server-side processing, and data storage components.

FIG. 2: User Interface Layout

Description: This figure provides a screenshot of the Wallow user interface, focusing on the #Issues and #Product features. It shows how issues are displayed and managed, as well as how product information is centralized within the platform.

FIG. 3: Real-Time Issue Reporting Flowchart

Description: A flowchart depicting the process of real-time issue reporting in Wallow. It outlines the steps from issue detection by a team member to notification dissemination across the team and subsequent collaborative resolution.

FIG. 4: AI Analytics and Sentiment Analysis Process

Description: This drawing illustrates the AI analytics module, specifically how it processes communication data to derive insights on issue frequency, recurring problems, and sentiment analysis. It also shows how AI-generated summaries are compiled and presented to the team.

FIG. 5: Notification System Diagram

Description: A diagram showing Wallow's inclusive notification system. It details how notifications about new and resolved issues are automatically disseminated to all team members regardless of their specific subscriptions or group memberships.

FIG. 6: Active Issues Management Interface

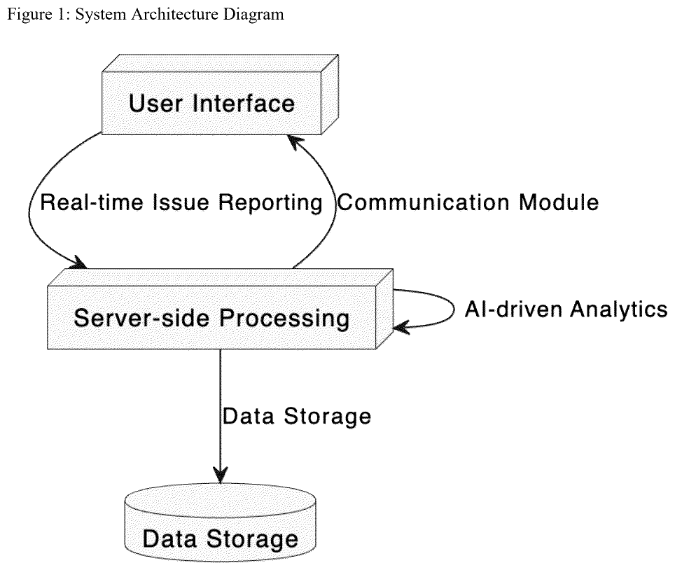

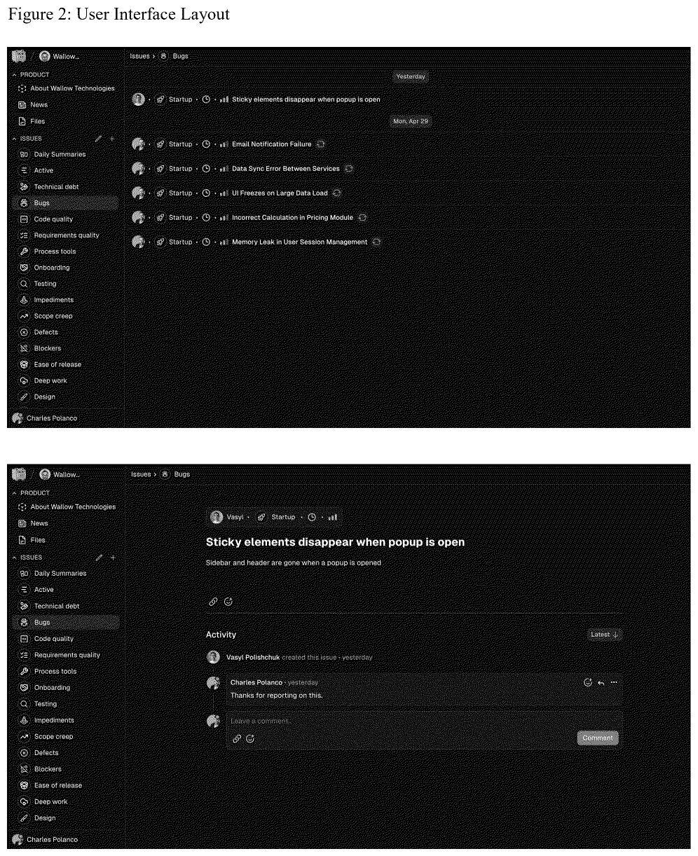

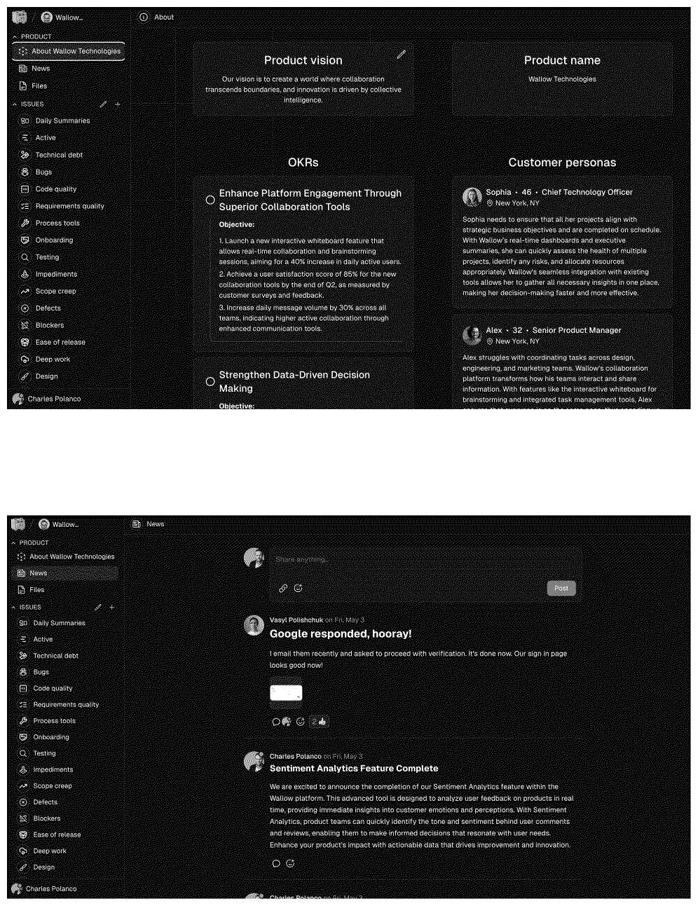

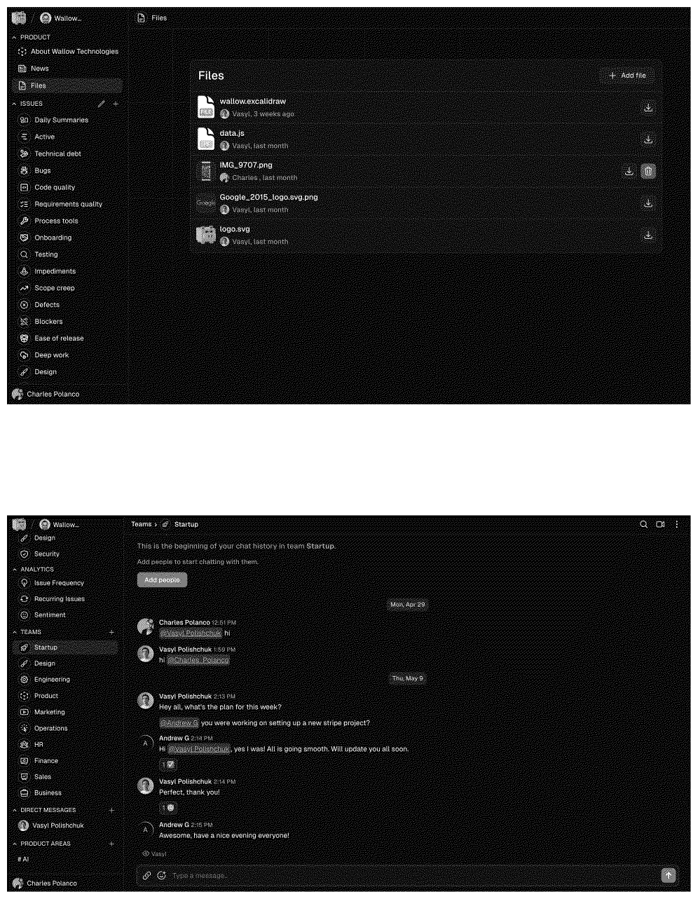

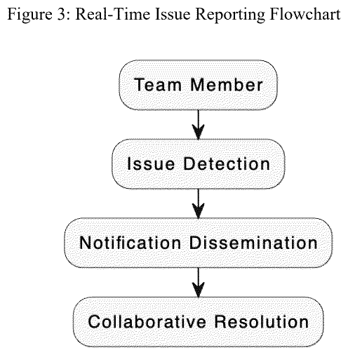

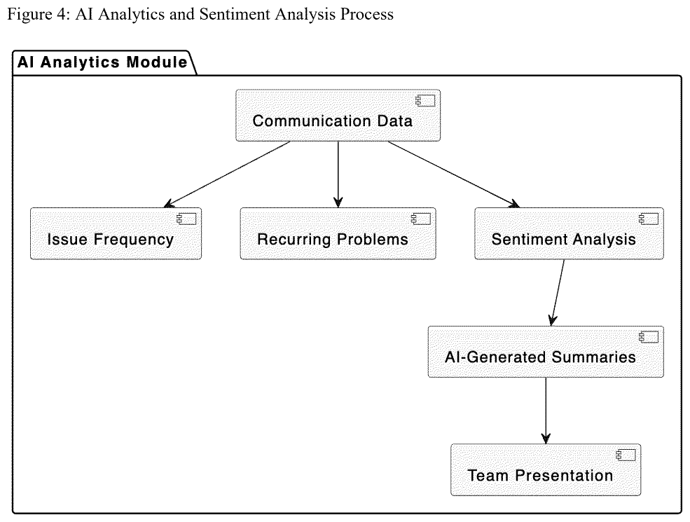

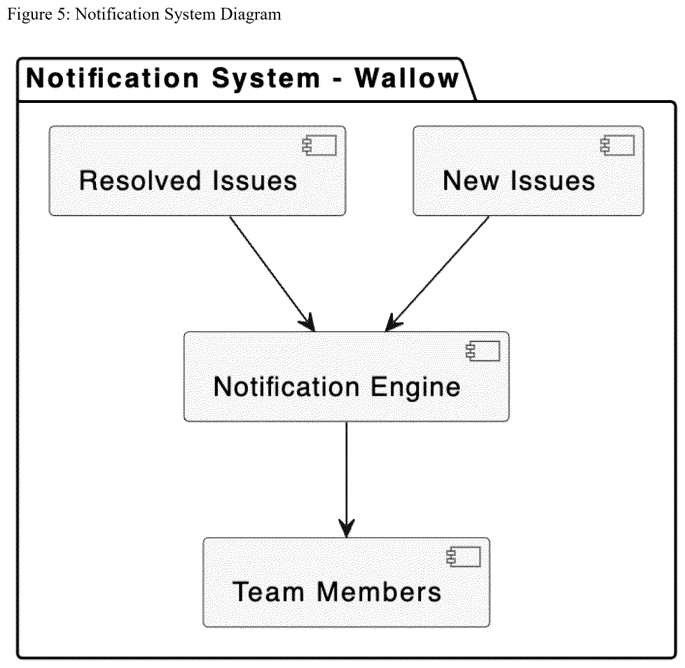

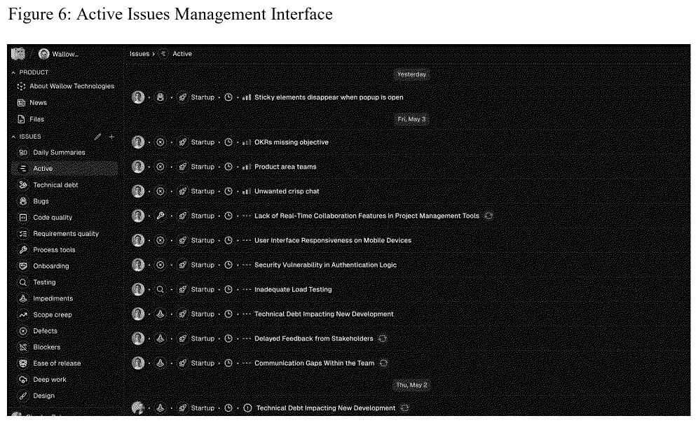

Description: This figure displays the user interface section dedicated to active issues. It highlights how unresolved issues are prioritized and visualized to keep the team focused on current challenges.

### DETAILED DESCRIPTION OF THE INVENTION

The present invention, Wallow, is a novel communication and collaboration platform designed specifically for product management teams. This detailed description provides an in-depth look at the various features and functionalities of Wallow that collectively enhance the efficiency and effectiveness of product development processes.

### Real-Time Issue Reporting System

Wallow integrates a real-time issue reporting system inspired by real-time traffic reporting technologies such as Waze. This system allows any team member to report issues as they occur, ensuring immediate awareness across the entire team.

### The System Includes

Instant Notification: As soon as an issue is reported, all team members receive an alert regardless of their current engagement within the platform.

Issue Tracking: Each reported issue is tracked in real-time, with updates visible to all team members, facilitating quick responses and collaborative problem-solving.

### AI-Driven Analytics

The AI component of Wallow utilizes advanced machine learning algorithms provided by integrations with platforms like OpenAI to analyze communication and project data. This analysis helps identify patterns and insights that are critical for effective management:

Sentiment Analysis: The AI evaluates the tone and urgency of communications related to reported issues, helping prioritize responses based on emotional cues.

Trend Analysis: Recurring issues are identified and reported to leadership, allowing for systemic changes to address these recurring challenges.

### Inclusive Notification System

Unlike conventional team communication tools which often require manual setup for notifications, Wallow's notification system ensures that all members of a workspace are informed of issues, updates, and resolutions without needing to join specific groups or channels:

Broad Reach: Notifications are sent to all workspace members by default, ensuring comprehensive coverage and involvement.

Customization Options: While the default is broad notification, users can customize their notification settings to focus on particular areas or issues if desired.

### Focus on Active Issues

To prevent oversight and ensure that pressing problems are addressed promptly, Wallow features a dedicated interface for active unresolved issues:

Active Issue Dashboard: This dashboard provides a constantly updated list of all active issues with tools for sorting and prioritizing based on various criteria such as urgency, impact, and recent activity.

### Integrated Team Functionality

Recognizing the diverse roles within product teams, Wallow allows for the creation and management of functional teams within the workspace:

Team Configuration: Users can set up teams based on departmental lines or project needs, facilitating targeted communication and collaboration.

Role-Based Access: Different access levels can be configured for different members, allowing for fine-grained control over who can view or modify certain types of information.

### Centralized Product Management Space

The #Product feature serves as a central hub for all key product information, ensuring that every team member has easy access to the same comprehensive set of data:

Document Sharing: Vision documents, OKRs, customer personas, and other critical files are stored and shared within this centralized space.

Integration with Existing Tools: Wallow integrates seamlessly with other tools to import and export data as needed, ensuring it can operate within the broader ecosystem of business tools.

Each of these features is designed not just to function independently but to interoperate seamlessly, creating a holistic tool tailored specifically to the needs of product management teams. The detailed operational aspects of these features as described in this section highlight the innovative nature of

Wallow and its advantages over existing solutions in the field.

1. A communication and collaboration platform comprising: a real-time issue reporting mechanism that enables any member within a workspace to report issues instantaneously; an inclusive notification system configured to automatically disseminate notifications about reported issues to all members of the workspace without requiring membership in specific channels or groups; and an artificial intelligence (AI) module configured to analyze communication data and generate insights related to issue frequency, recurring problems, and sentiment analysis.

2. A method for managing communication within a product management team implemented on a computer platform, the method comprising: receiving inputs from users regarding issues affecting a product development process; automatically notifying all members of a workspace about the issues without requiring the members to be part of predetermined groups or channels; analyzing the issues using an AI module to determine patterns, trends, and sentiments; and displaying the issues and corresponding analysis in a format that facilitates quick review and action by the team members.

3. A non-transitory computer-readable medium storing a computer program which, when executed by a processor, causes a communication and collaboration system to perform operations comprising: real-time issue reporting; inclusive notification dissemination; and AI-driven analytics and summarization as described in claim 1.

4. The platform of claim 1, wherein the real-time issue reporting mechanism is further configured to allow users to input data regarding the nature of the issue, its urgency, and any other relevant information.

5. The platform of claim 4, further configured to display the reported issues in a centralized dashboard accessible by all workspace members.

6. The platform of claim 1, wherein the AI module is further configured to provide daily summaries of unresolved issues based on the analysis of communication data.

7. The platform of claim 6, further configured to prioritize issues based on the urgency and impact derived from sentiment analysis.

8. The platform of claim 1, further comprising a dedicated section for active issues that only lists unresolved issues to maintain focus on current challenges.

9. The platform of claim 8, further comprising configuration options that allow users to customize the visibility and notifications of issues based on personal or team-specific preferences.

10. The platform of claim 1, wherein the inclusive notification system includes options for users to customize notification settings to receive alerts based on specific criteria such as issue type, severity, or related project area.

11. The platform of claim 10, further configured to integrate with external notification services to extend the reach of issue alerts beyond the platform.

12. The method of claim 2, further including generating and displaying a list of active unresolved issues to maintain focus on high-priority challenges.

13. The method of claim 12, further including allowing users to comment on and update the status of issues directly within the platform, fostering collaborative problem-solving.

14. A non-transitory computer-readable medium storing a computer program which, when executed by a processor, causes a communication and collaboration system to perform operations comprising generating and displaying a list of active unresolved issues to maintain focus on high-priority challenges as described in claim 12.

14. The non-transitory computer-readable medium of claim 14, further comprising allowing users to comment on and update the status of issues directly within the platform.

15. The non-transitory computer-readable medium of claim 15, further configured to foster collaborative problem-solving.

16. The platform of claim 1, further comprising traditional project management tools including task assignment, milestone tracking, and progress reporting.
